(19) United States
(12) Patent Application Publication
(10) Pub. No.: US 2004/0138356 A1
(43) Pub. Date: Jul. 15, 2004

(54) Primer composition

(76) Inventors: Akihiro Miyata, Kanagawa Prefecture (JP); Kazunori Ishikawa, Kanagawa Prefecture (JP); Mineto Yamaguchi, Kanagawa Prefecture (JP); Kenichi Tsubota, Kanagawa Prefecture (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/742,809

(22) Filed: Dec. 23, 2003

(30) Foreign Application Priority Data
Dec. 27, 2002 (JP) 2002-380269

(51) Int. Cl. C08L 1/00

(52) U.S. Cl. 524/262; 524/502

(57) ABSTRACT

The present invention provides a primer composition containing a chlorinated polyolefin resin having a chlorine content of 30% by weight or less and an aminosilane compound and/or a ketimine silane compound having specific structures. The primer composition of the present invention has satisfactory adhesion to a polyolefin material such as polyethylene and polypropylene, and in addition, has satisfactory adhesion with a modified silicone sealing material.

### BACKGROUND OF THE INVENTION

1. Field of the Invention

The present invention relates to a primer composition, and more specifically to a primer composition capable of improving adhesion to an adherend with poor adhesion such as a polyolefin, in particular, polypropylene, polyethylene, or the like.

2. Description of the Related Art

Recently, molded products made of synthetic resins (plastic material, for example) such as polyolefin are used in place of metallic parts in various industrial areas of automobiles, household appliances, or the like for purposes of weight saving, cost reduction, or the like. In addition, surfaces of parts made of those molded products are generally subjected to coating, so satisfactory coating property is required for surfaces of parts. Therefore, it is known that a primer for improving the coating property is generally coated on a surface of the molded products made of synthetic resins before a final coating.

However, a film consisting of a conventional primer lacks in adhesion to polyolefin (hereinafter also referred to as polyolefin material) such as polyethylene and polypropylene. When trying to secure the adhesion, there arises a problem in that the film has poor adhesion with a sealing material or a sealant such as a urethane material and a modified silicone sealing material.

In order to solve the problem described above, JP 10-292085 A discloses a resin composition containing a vinyl-modified chlorinated polyolefin polymer obtained by polymerizing, (A) in the presence of a chlorinated polyolefin resin, (B) (b1) an unsaturated organic silane compound represented by a prescribed formula, (b2) a polymerizable monomer having two or more polymerizable double bonds, (b3) a polymerizable monomer having a hydroxyl group, and (b4) a polymerizable monomer having a carboxyl group.

In addition, JP 11-106600 A discloses a resin composition containing: a vinyl modified chlorinated polyolefin polymer obtained by polymerizing, (A) in the presence of a chlorinated polyolefin resin having a chlorine content of 50% by weight or less, (B) a polymerizable monomer mixture containing, as essential ingredients, (b1) an unsaturated organic silane compound represented by a prescribed formula, (b2) a polymerizable monomer having two or more polymerizable double bonds, and (b3) a polymerizable monomer having a carboxyl group; and (C) epoxidized polybutadiene.

However, the resin compositions disclosed in the above-mentioned JP 10-292085 A and JP 11-106600 A have insufficient adhesion with the polyolefin, in particular, polyethylene, and with a modified silicone sealing material, and there is room for improvement.

### SUMMARY OF THE INVENTION

Therefore, an object of the present invention is to provide a primer composition having satisfactory adhesion to a polyolefin material such as polyethylene and polypropylene, and in addition, having satisfactory adhesion with a modified silicone sealing material.

The inventors of the present invention found out that a primer composition, containing a specific chlorinated polyolefin resin and an aminosilane compound and/or a ketimine silane compound having prescribed structures, has satisfactory adhesion to a polyolefin material such as polyethylene and polypropylene, and in addition, is a primer composition having satisfactory adhesion with a modified silicone sealing material, thereby completing the primer composition of the present invention. That is, the present invention provides the following primer compositions (1) to (4).

(1) A primer composition containing:

a chlorinated polyolefin resin having a chlorine content of 30% by weight or less; and

one or more kinds of a silane compound selected from the group consisting of a secondary aminosilane compound having a structure represented by the following formula (1), a secondary aminosilane compound having a structure represented by the following formula (2), and a ketimine silane compound having a structure represented by the following formula (3) (a first aspect of the invention).

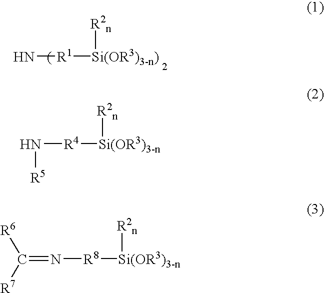

(wherein, R¹ denotes an alkylene group having 1 to 12 carbons; R² and R³ respectively denote independent alkyl groups having 1 to 8 carbons and which may be branched; R⁴ denotes an alkylene group having 1 to 12 carbons; R⁵ denotes an alkyl group having 1 to 8 carbons, an aralkyl group having 7 to 18 carbons, or an aryl group having 6 to 18 carbons, all of which may be branched; R⁶ and R⁷ respectively denote independent monovalent organic groups having 1 to 12 carbons; R⁸ denotes a divalent organic group having 1 to 12 carbons; and n is an integer of 0 to 2. In addition, two or more of R¹, R², and R³ may be identical or different, respectively.)

(2) A primer composition according to the item (1) described above, further containing a phenol resin.

(3) A primer composition containing:

a chlorinated polyolefin resin having a chlorine content of 30% by weight or less;

a primary aminosilane compound having a structure represented by the following formula (4); and

a phenol resin (a second aspect of the invention).

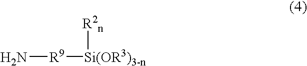

(wherein, R¹ denotes an alkylene group having 1 to 12 carbons; R² and R³ respectively denote independent alkyl groups having 1 to 8 carbons and which may be branched; R⁴ denotes an alkylene group having 1 to 12 carbons; R⁵ denotes an alkyl group having 1 to 8 carbons, an aralkyl group having 7 to 18 carbons, or an aryl group having 6 to 18 carbons, all of which may be branched; R⁶ and R⁷ respectively denote independent monovalent organic groups having 1 to 12 carbons; R⁸ denotes a divalent organic group having 1 to 12 carbons; R⁹ denotes an alkylene group having 1 to 12 carbons; and n is an integer of 0 to 2. In addition, two or more of R¹, R², and R³ may be identical or different, respectively.)

(4) A primer composition according to any one of the items (1) to (3) described above, characterized in that the silane compound is contained in 0.5 to 10 parts by weight with respect to 100 parts by weight of the chlorinated polyolefin resin.

### DETAILED DESCRIPTION OF THE INVENTION

Hereinafter, a primer composition of the present invention is described in detail.

The primer composition according to a first aspect of the present invention is a primer composition containing:

a chlorinated polyolefin resin having a chlorine content of 30% by weight or less; and

one or more kinds of a silane compound selected from the group consisting of a secondary aminosilane compound having a structure represented by the following formula (1), a secondary aminosilane compound having a structure represented by the following formula (2), and a ketimine silane compound having a structure represented by the following formula (3).

Hereinbelow, each of the components used for the primer composition according to the first aspect of the present invention is described.

<Chlorinated Polyolefin Resin>

A chlorinated polyolefin resin used for the primer composition according to the first aspect of the present invention is a chlorinated polyolefin resin having a chlorine content of 30% by weight or less. Specific examples thereof may include a chlorinated polyethylene resin, a chlorinated polypropylene resin, a maleic anhydride-modified chlorinated polyethylene resin, a urethane-modified chlorinated polypropylene resin, a chlorinated ethylene-propylene copolymer, and a chlorinated ethylene-vinyl acetate copolymer, each having a chlorine content of 30% by weight or less. Of those, use of a chlorinated polypropylene resin is preferable because the adhesion of the obtained primer composition becomes satisfactory.

Further, a chlorine content of the above chlorinated polyolefin resin is suitably defined considering various intended film performances (such as adhesion). Unless the film performance degrades significantly, the minimum limit of the chlorine content is not restricted; however, the content of 10 to 30% by weight is preferable from such a reason that the adhesion of the obtained primer composition to a polyolefin material excels.

The above chlorine content is a value measured by a combustion method.

A weight average molecular weight (standard polyethylene equivalent obtained using gel permeation chromatography) of the above chlorinated polyolefin resin is preferably 10,000 to 300,000, and more preferably 30,000 to 250,000. If a range of the weight average molecular weight is in the above range, solvent resistance of the obtained primer composition becomes satisfactory, thus is preferable.

Further, as the above chlorinated polyolefin resin, ones commercially available with trade names such as “SUPERCHLON™” available from Sanyo-Kokusaku Pulp Co., Ltd., “HARDLEN™” available from Toyo Kasei Kogyo Co., Ltd., “DAISOLAC™” available from Osaka Soda Co., Ltd., and “UNISTOLE™” available from Mitsui Petrochemicals Ltd. can be used, for example.

<Silane Compounds>

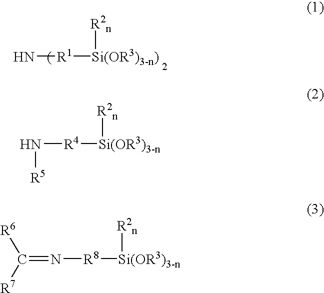

In the formula, R¹ denotes an alkylene group having 1 to 12 carbons; R² and R³ respectively denote independent alkyl groups having 1 to 8 carbons and which may be branched; R⁴ denotes an alkylene group having 1 to 12 carbons; R⁵ denotes an alkyl group having 1 to 8 carbons, an aralkyl group having 7 to 18 carbons, or an aryl group having 6 to 18 carbons, all of which may be branched; R⁶ and R⁷ respectively denote independent monovalent organic groups having 1 to 12 carbons; R⁸ denotes a divalent organic group having 1 to 12 carbons; and n is an integer of 0 to 2. In addition, two or more of R¹, R², and R³ may be identical or different, respectively.

A silane compound used for the primer composition according to the first aspect of the present invention is one or more kinds of a silane compound selected from the group consisting of a secondary aminosilane compound having a structure represented by the above formula (1), a secondary aminosilane compound having a structure represented by the above formula (2), and a ketimine silane compound having a structure represented by the above formula (3).

The primer composition according to the first aspect of the present invention containing those silane compounds is useful because the silane compounds improve the adhesion with a modified silicone sealing material and contributes to an enhancement of storage stability and water resistance.

A silyl group in the aminosilane compounds represented by the above formulae (1) and (2) and the ketimine silane compound represented by the above formula (3) has preferably at least one hydrolyzable substituent, more preferably two or more thereof, and particularly preferably three or more thereof. If the silyl group has two or more hydrolyzable substituents, an adhesion imparting effect of the above aminosilane compounds and ketimine silane compound and the adhesion with a modified silicone sealing material are further enhanced.

Specific examples of the hydrolyzable substituent may include a hydrogen atom, an alkoxy group, an acyloxy group, an amino group, an amide group, an aminooxy group, a mercapto group, and an alkenyloxy group. Of those, an alkoxy group is preferable since it has moderate hydrolyzable property.

By selecting a hydrolyzable substituent, a rate of hydrolysis and a time period for expressing adhesion can be adjusted according to intended applications.

The above aminosilane compounds are described.

The above aminosilane compounds are secondary aminosilane compounds having an amino group and the silyl group described above and are aminosilane compounds represented by the following formulae (1) and (2).

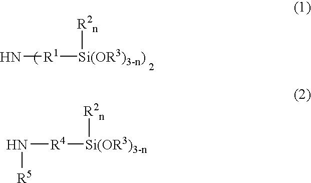

In the above formula (1), R¹ denotes an alkylene group having 1 to 12 carbons; R² and R³ respectively denote independent alkyl groups having 1 to 8 carbons and which may be branched; and n is an integer of 0 to 2. In addition, two or more of R¹, R², and R³ may be identical or different, respectively.

Specific examples of R¹, which is an alkylene group having 1 to 12 carbons, may include a methylene group, an ethylene group, a trimethylene group, a tetramethylene group, a pentamethylene group, a hexamethylene group, and an octamethylene group. A trimethylene group is more preferable in terms of easy availability and excellent adhesion.

Specific examples of R² and R³, which are each an alkyl group having 1 to 8 carbons and may be branched, may include methyl group, ethyl group, propyl group, isopropyl group, n-butyl group, isobutyl group, sec-butyl group, tert-butyl group, n-pentyl group, isopentyl group, neopentyl group, tert-pentyl group, 1-methylbutyl group, 2-methylbutyl group, and 1,2-dimethylpropyl group, and these groups may contain a double bond or a triple bond. Of those, methyl group and ethyl group are preferable.

Specific examples of the aminosilane compound represented by the above formula (1) here may include N,N-bis[(3-trimethoxysilyl)propyl]amine, N,N-bis[(3-triethoxysilyl)propyl]amine, and N,N-bis[(3-tripropoxysilyl)propyl]amine.

In the above formula (2), R² and R³ respectively denote independent alkyl groups having 1 to 8 carbons and which may be branched; R⁴ denotes an alkylene group having 1 to 12 carbons; R⁵ denotes an alkyl group having 1 to 8 carbons, an aralkyl group having 7 to 18 carbons, or an aryl group having 6 to 18 carbons, all of which may be branched; and n is an integer of 0 to 2. In addition, two or more of R² and R³ may be identical or different, respectively.

R² and R³ are basically identical to the ones described for the above formula (1).

Specific examples of R⁴, which is an alkylene group having 1 to 12 carbons, can include an alkylene group exemplified for R¹ of the above formula (1), and it is preferably an alkylene group having 2 to 6 carbons.

Specific examples of R⁵, which is an alkyl group having 1 to 8 carbons and may be branched, can include an alkyl group exemplified for R² and R³ of the above formula (1).

Specific examples of the aminosilane compound represented by the above formula (2), of which R⁵ is an alkyl group having 1 to 8 carbons and which may be branched, may include 3-butylaminopropyltrimethoxysilane (Dynasilane 1189, available from Degussa Hüls AG) and N-ethylaminoisobutyl trimethoxysilane (available from Nippon Unicar Co., Ltd.).

Specific examples of R⁵, which is an aralkyl group having 7 to 18 carbons and may be branched, can include a benzyl group and a phenethyl group.

Specific examples of R⁵, which is an aryl group of having 6 to 18 carbons, can include a phenyl group, a methylphenyl group (toluyl group), a dimethylphenyl group, and an ethylphenyl group. In addition, examples of a substituent of an aryl group preferably include, in addition to the above alkyl groups, an alkoxy group such as methoxy group and an ethoxy group, and a group consisting of a halogen atom such as a fluorine atom and a chlorine atom. One or two or more of those substituents may be contained, and position of substitution thereof is not restricted.

Specific examples of the aminosilane compound represented by the above formula (2), of which R⁵ is an aryl group having 6 to 18 carbons, may include N-phenyl-γ-aminopropyltrimethoxysilane (available from Nippon Unicar Co., Ltd.).

One kind of the aminosilane compound represented by the above formulae (1) and (2) may be used independently, or two or more kinds thereof may be combined and used for the primer composition according to the first aspect of the present invention.

Further, of the above aminosilane compounds exemplified, use of an aminosilane compound of N,N-bis[(3-trimethoxysilyl)propyl]amine, 3-butylaminopropyltrimethoxysilane, and N-phenyl-γ-aminopropyltrimethoxysilane is preferable because the adhesion of the obtained primer composition becomes satisfactory.

Next, the above ketimine silane compound is described.

The above ketimine silane compound is a compound having a ketimine group (ketimine bond) and the silyl compound described above and is a ketimine silane compound represented by the following formula (3).

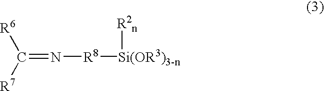

In the above formula (3), R² and R³ respectively denote independent alkyl groups having 1 to 8 carbons and which may be branched; R⁶ and R⁷ respectively denote independent monovalent organic groups having 1 to 12 carbons; R⁸ denotes a divalent organic group having 1 to 12 carbons; and n is an integer of 0 to 2. In addition, two or more of R² and R³ may be identical or different, respectively.

R² and R³ are basically identical to the ones described in the above formula (1).

R⁶ and R⁷ are respectively independent monovalent organic groups having 1 to 12 carbons, and is preferably respectively independent monovalent organic groups (aliphatic groups, alicyclic groups, and aromatic groups) having 1 to 6 carbons, and more preferably respectively independent alkyl groups having 1 to 6 carbons. Examples of a monovalent organic group having 1 to 12 carbons and an alkyl group having 1 to 6 carbons can preferably include the alkyl groups exemplified for R² and R³ of the above formula (1).

R⁸ is a divalent organic group having 1 to 12 carbons and is preferably an alkylene group having 2 to 6 carbons. Examples of a divalent organic group having 1 to 12 carbons and an alkylene group having 2 to 6 carbons can preferably include the alkylene group exemplified for R¹ of the above formula (1).

Specific examples of the ketimine silane compound represented by the above formula (3) may include N-(1,3-dimethylbutylidene)-3-(trimethoxysilyl)-1-propanamine, N-(1,3-dimethylbutylidene)-3-(triethoxysilyl)-1-propanamine, N-(1,3-dimethylbutylidene)-3-(methyl dimethoxysilyl)-1-propanamine, N-(1,3-dimethylbutylidene)-3-(methyl diethoxysilyl)-1-propanamine, and the like.

One kind of the ketimine compound represented by the above formula (3) may be used independently, or two or more kinds thereof may be combined and used for the primer composition according to the first aspect of the present invention.

Further, use of an aminosilane compound of as N-(1,3-dimethylbutylidene)-3-(trimethoxysilyl)-1-propanamine (available from Chisso Corporation), among the above ketimine compounds exemplified, is preferable because the adhesion of the obtained primer composition becomes satisfactory.

A primer composition according to a second aspect of the present invention contains a phenol resin further to a composition of the first aspect of the present invention.

Further, use of an aminosilane compound such as N,N-bis[(3-trimethoxysilyl)propyl]amine, 3-butylaminopropyltrimethoxysilane, and N-phenyl-γ-aminopropyltrimethoxysilane, among the above aminosilane compounds exemplified, is preferable because the adhesion of the obtained primer composition becomes satisfactory.

<Phenol Resin>

A phenol resin used for the primer composition according to the second aspect of the present invention is a thermo-setting resin obtained through an addition condensation reaction of phenols and aldehydes and may be a novolak-type synthesized by adding an acid catalyst or a resol-type synthesized using a basic catalyst.

Here, specific examples of the above phenols may include monovalent and polyvalent phenols such as phenol, cresol, xylenol, naphthol, p-tert-butylphenol, bisphenol A, and resorcinol. On the other hand, specific examples of the aldehydes may include formaldehyde, paraformaldehyde, and the like.

Further, a phenol resin suitably modified with an aromatic hydrocarbon resin, dimethoxy para-xylene, dicyclopentadiene, a magnesium chelate, or the like can be used.

Among those, use of the phenol resin modified with a magnesium chelate (hereinafter, referred to as magnesium chelate modified) is preferable because the adhesion of the obtained primer composition to a polyolefin material becomes satisfactory.

Further, as the above phenol resin, a phenol with a tradename “Hitanol” commercially available from Hitachi Chemicals Co., Ltd. or the like can be used, for example.

The primer composition of the second aspect of the present invention contains a phenol resin further to the primer composition of the first aspect of the present invention, and thus has further excellent storage stability in addition to the property of the first aspect of the present invention.

The adhesion is superior in the evaluation test such as type 2 adhesion test of resistance to hot water. The type 2 test is made in a manner that the test piece is cured in an environment of 20° C. and 55% relative humidity for 5 days, then immersed in hot water at 50° C. for 7 days.

A primer composition according to a third aspect of the present invention contains:

a chlorinated polyolefin resin having a chlorine content of 30% by weight or less;

a primary aminosilane compound having a structure represented by the following formula (4); and

a phenol resin.

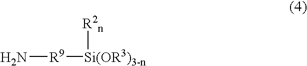

In the above formula (4), R² and R³ respectively denote independent alkyl groups having 1 to 8 carbons and which may be branched; R⁹ denotes an alkylene group having 1 to 12 carbons; and n is an integer of 0 to 2. In addition, two or more of R² and R³ may be identical or different, respectively.

Hereinafter, each of the components used for the primer composition according to the third aspect of the present invention is described.

<Chlorinated Polyolefin Resin>

The above chlorinated polyolefin resin used for the primer composition according to the third aspect of the present invention is basically identical to the chlorinated polyolefin resin according to the first aspect of the present invention described above.

<Silane Compound>

A silane compound used for the primer composition according to the third aspect of the present invention is a primary aminosilane compound having a structure represented by the above formula (4).

The primer composition according to the third aspect of the present invention, similar to the primer composition according to the first aspect of the present invention, is useful because the silane compound improves adhesion with a modified silicone sealing material and contributes to an enhancement of storage stability and water resistance.

A silyl group in the aminosilane compound represented by the above formula (4), similar to the primer composition according to the first aspect of the present invention, preferably contains at least one hydrolyzable substituent, more preferably two or more thereof, and particularly preferably three or more thereof. If the silyl group contains two or more hydrolyzable substituents, the adhesion imparting effect of the above aminosilane compound and ketimine silane compound and the adhesion with a modified silicone sealing material are further enhanced.

The hydrolyzable substituent here is basically identical to the hydrolyzable substituent according to the first aspect of the present invention described above.

Specific examples of the compounds represented by the above formula (4) may include γ-aminopropyltrimethoxysilane, γ-aminopropyltriethoxysilane, γ-aminopropylmethyldimethoxysilane, γ-aminopropylmethyldiethoxysilane, and the like.

One kind of the aminosilane compound represented by the above formula (4) may be used independently, or two or more kinds may be combined and used for the primer composition according to the third aspect of the present invention.

Further, among the above aminosilane compounds exemplified, use of an aminosilane compound of γ-aminopropyltrimethoxysilane is preferable because the adhesion of the obtained primer composition becomes satisfactory.

The primer composition according to the first, second, and third aspects of the present invention described above (hereinafter, simply referred to as primer composition of the present invention) can contain a film forming resin, in addition to a chlorinated polyolefin resin, as desired.

The above film forming resin is lowly active or inactive to an amino group and an imino group. In addition, the film forming resin is not particularly limited as long as it is a resin having a film forming property, and a resin generally used can be used. Specific examples may preferably include an acrylic resin, a polyester polyurethane resin, a chlorinated rubber, a terpene resin, and the like.

Further, the primer composition of the present invention can contain, in addition to the above components, an organic solvent as desired for improving preparability and workability of an applying step.

The organic solvent is not particularly limited as long as it is inactive to the above components and has an appropriate volatility.

Specific examples of the organic solvent may include methylethyl ketone, dimethyl acetamide, acetone, ethyl acetate, butyl acetate, Cellosolve acetate, mineral spirit, toluene, xylene, n-hexane, isohexane, methylene chloride, tetrahydrofuran, ethyl ether, and dioxane. One kind thereof may be used independently, or two or more kinds can be combined and used. Among those, methylethyl ketone, ethyl acetate, butyl acetate, isohexane, and toluene are preferably used. Further, those organic solvents are preferably used after sufficient drying.

The primer composition of the present invention can contain other additives as required.

Specific examples of the additives may include: an inorganic pigment such as lampblack, titanium white, red oxide, titanium yellow, zinc white, red lead, cobalt blue, iron black, and aluminum powder; an organic pigment such as Neozapon Black RE, Neo Black RE, Orasol Black CN, Orasol Black Ba (all available from Ciba-Geigy Ltd.), Spilon Blue 2BH (available from Hodogaya Chemical Co., Ltd.); and an ultraviolet absorber such as Cyasorb (Cyasorb UV-24 Light Absorber, available from American Cyanamide Corporation) and Uvinul (Uvinul D-49, D-50, N-35, N-539, available from General Aniline and Film Corporation). Containing those additives allows the primer composition to shield or absorb ultraviolet rays or visible rays and is effective for improving weatherability of the primer composition.

Further, the primer composition of the present invention may contain: a catalyst such as a tertiary amine or an organic tin compound; a filler such as glass powder, clay, powdered silica gel, microfine powdery silicic acid, and molecular sieves (which also has water absorbing property); a thickener; a plasticizer such as butylbenzyl phthalate, dioctyl phthalate, dibutyl phthalate, and chlorinated paraffin; and a stabilizer such as diethyl malonate.

In the primer composition of the present invention, a content of the above silane compound (solid) is 0.5 to 20 parts by weight, preferably 0.5 to 15 parts by weight, more preferably 0.5 to 10 parts by weight with respect to 100 parts by weight of the chlorinated polyolefin resin (as solids). If the content of the silane compound is in the above range, the adhesion of the obtained primer composition to a polyolefin material becomes satisfactory, and storage stability and water resistance become satisfactory, thus being preferable.

Further, in the primer composition according to the second and the third aspects of the present invention, a content of the above phenol resin (as solids) is 50 to 400 parts by weight, preferably 50 to 350 parts by weight, more preferably 50 to 300 parts by weight with respect to 100 parts by weight of the chlorinated polyolefin resin (as solids). If the content of the phenol resin is in the above range, the adhesion of the primer composition to a polyolefin material becomes satisfactory, and storage stability becomes satisfactory even when using a primary and/or secondary aminosilane compound as a silane compound, thus being preferable.

In the primer composition of the present invention, a blending amount of the organic solvent desirably contained is preferably 100 to 1,000 parts by weight with respect to 100 parts by weight of the total solids in the primer composition of the present invention. If the blending amount of the organic solvent is in the above range, the preparability of the primer composition to be obtained and workability of the applying step improve. Further, the primer composition has satisfactory adhesion to a polyolefin material such as polyethylene and polypropylene, and adhesion with a modified silicon sealing material also becomes satisfactory, thus is preferable.

The primer composition of the present invention having such a composition has an effect of imparting satisfactory adhesion to various adherends, in particular, a polyolefin material such as poorly adhesive polyethylene and polypropylene and providing satisfactory adhesion with a modified silicone sealing material as described above.

The reason for the satisfactory adhesion with a modified silicone sealing material is considered that a silyl group of the above silyl compound is a hydrolyzable substituent described above.

A method of producing the primer composition of the present invention is not particularly limited, and the primer composition can be obtained, for example, by: mixing the above chlorinated polyolefin resin, the above silane compound, a phenol resin in the case of the primer composition according to the second and third aspects of the present invention, a film forming resin and an organic solvent desirably contained according to the property of the primer composition or the like, carbon black as required, other additives, or the like; sufficiently kneading the mixture using a mixing device such as a ball mill at room temperature or under heating (40 to 60° C., 40° C. for example); and uniformly dispersing the kneaded product.

Further, the primer composition of the present invention can be applied to an adherend using an applying method generally adopted such as a brush coating method, a spray coating method, a wire bar method, a blade method, a roll coating method, and a dipping method.

The primer composition of the present invention can be preferably used to a sealing material or a sealant. Specifically, the primer composition of the present invention shows stable adhesion not only to glass and aluminum but also to an adherend of a polyolefin material which is a poorly adhesive member, and also shows stable adhesion to silicon, polyurethane, and modified silicone sealing materials. In addition, as long as a combination of the above adherend and a sealing material is used, any combination provides excellent adhesion and may be suitably used. A modified silicone sealing material here is a sealing material having a modified silicone resin as a main component. The modified silicone resin is a resin of which a terminal of a polyether main chain is silane-modified to contain a hydrolyzable silyl group and is commercially available from Kaneka Corporation as a modified silicone resin, for example.

That is, a specific example of a laminated body obtained by using the primer composition of the present invention is a laminated body obtained by the following production method.

The primer composition of the present invention is applied to required sections of respective sheets, blocks, and surface layers of adherends of a polyolefin material such as a polyethylene resin, a polyethylene-polypropylene copolymer or a blend resin, a polypropylene resin, and by diluting the primer composition with a solvent for an appropriate viscosity and concentration. Subsequently, silicone, polyurethane, and modified silicone sealing materials are adhered thereon. The obtained laminated body exhibits stable adhesion.

### EXAMPLES

Hereinafter, the present invention is described more specifically by way of examples; however, the present invention is not limited to the following examples.

### Examples 1 to 16 and Comparative Examples 1 to 4

A chlorinated polypropylene resin (chlorinated PP), secondary aminosilane 1, primary aminosilane 2, secondary aminosilane 3, ketimine silane, a phenol resin, and toluene were mixed according to the respective formulations (parts by weight) shown in Table 1 below. Each of the resulting mixtures was sufficiently kneaded at room temperature using a ball mill to prepare a primer composition.

Each of the obtained primer compositions was evaluated for storage stability and adhesion to polyethylene by the following methods. The results are shown in Table 1 below.

<Storage Stability>

Each of the obtained primer compositions was stored in a closed container at 20° C. and 55% RH, and a condition of the composition after 5 days was observed. When no gelation or solidification was observed, the composition was represented by a circle (◯), and when gelation was observed, the composition was represented by an x (^{x}).

<Adhesion to Polyethylene>

Each of the obtained primer compositions was applied to a surface of an adherend, polyethylene, and was left to stand for at 20° C. and 55% relative humidity (RH) for 30 minutes. Then, a modified silicone sealing material (“Super One”, available from Yokohama Rubber Co., Ltd.) was contact bonded to a surface of the thus applied primer composition in a thickness of 3 mm to prepare a test piece.

After curing the test piece according to the conditions below, a vicinity of a boundary between the primer composition and the above modified silicone sealing material contact bonded was cut by a knife, and the cut portion was hand-peeled (hold and pull with a hand). The peeled condition was observed (hand-peeling test by cutting with a knife) to evaluate a condition of a peeled surface (broken surface).

(1) Initial Adhesion

The test piece was cured in an environment of 20° C. and 55% relative humidity for 5 days.

(2) Adhesion Resistance to Hot Water

The test piece was cured in an environment of 20° C. and 55% relative humidity for 5 days, then immersed in hot water at 50° C. for 2 days.

For evaluation, a sealing material with 90% or more cohesion failure was represented by “⊚”, one with 80% or more to less than 90% was represented by “◯”, one with 70% or more to less than 80% was represented by “Δ”, and one with less than 70% was represented by “^{x}”.

Adhesion of a primer composition to a polyethylene sheet is preferably “⊚” according to the above evaluation.

TABLE 1-1
(Component units: weight ratio)

| | | Example | | | | Comparative Example | | | | |
|---|---|---|---|---|---|---|---|---|---|---|
| | NV | 1 | 2 | 3 | 4 | 1 | 2 | 5 | 6 | 7 |
| Chlorinated PP | 20% | 100 | 100 | 100 | 100 | 100 | 100 | 100 | 100 | 100 |
| Secondary aminosilane 1 | 100% | 0.3 | 1.0 | | | | | | | |
| Primary aminosilane 2 | 100% | | | | | 0.3 | 1.0 | | | |
| Ketimine silane | 100% | | | 0.3 | 1.0 | | | | | |
| N- | 100% | | | | | | | 0.5 | | 0.5 |
| ethylaminoethylamine | | | | | | | | | | |
| Vinyltrimethoxysilane | 100% | | | | | | | | 0.5 | 0.5 |
| Toluene | | 80 | 80 | 80 | 80 | 80 | 80 | 80 | 80 | 80 |
| <Storage stability> | | | | | | | | | | |
| 20° C., 55% RH × 5days | | ◯ | ◯ | ◯ | ◯ | X (gelation) | X (gelation) | ◯ | ◯ | ◯ |
| <Adhesion>*¹ | | | | | | | | | | |
| (1) Initial | | ⊚ | ⊚ | ⊚ | ⊚ | — | — | X | X | X |
| (2) Resistance to hot | | ⊚ | ⊚ | ⊚ | ⊚ | — | — | X | X | X |
| water | | | | | | | | | | |

(NV: solid concentration)
*¹adhesion to polyethylene

TABLE 1-2
(Component units: weight ratio)

| | | | | | | | | | | | | | | Comparative | |
|---|---|---|---|---|---|---|---|---|---|---|---|---|---|---|---|
| | | Example | | | | | | | | | | | | Example | |
| | NV | 5 | 6 | 7 | 8 | 9 | 10 | 11 | 12 | 13 | 14 | 15 | 16 | 3 | 4 |
| Chlorinated PP | 20% | 100 | 100 | 100 | 100 | 100 | 100 | 100 | 100 | 100 | 100 | 100 | 100 | 100 | 100 |
| Secondary | 100% | 0.3 | 1.0 | 1.0 | | | | | | | | | | | |
| aminosilane 1 | | | | | | | | | | | | | | | |
| Primary | 100% | | | | 0.3 | 1.0 | 1.0 | | | | | | | | |
| aminosilane 2 | | | | | | | | | | | | | | | |
| Secondary | 100% | | | | | | | 0.3 | 1.0 | 1.0 | | | | | |
| aminosilane 3 | | | | | | | | | | | | | | | |
| Ketimine | 100% | | | | | | | | | | 0.3 | 1.0 | 1.0 | | |
| silane | | | | | | | | | | | | | | | |
| Phenol resin | 50% | 40 | 40 | 80 | 40 | 40 | 80 | 40 | 40 | 80 | 40 | 40 | 80 | 40 | 80 |
| Toluene | | 100 | 100 | 100 | 100 | 100 | 100 | 100 | 100 | 100 | 100 | 100 | 100 | 80 | 80 |

| | | | | | | | | | | | | | | |
|---|---|---|---|---|---|---|---|---|---|---|---|---|---|---|
| <Storage stability> | | | | | | | | | , | , | | | | |
| 20° C., | ◯ | ◯ | ◯ | ◯ | ◯ | ◯ | ◯ | ◯ | ◯ | ◯ | ◯ | ◯ | ◯ | ◯ |
| 55% RH × 5days | | | | | | | | | | | | | | |
| <Adhesion>*¹ | | | | | | | | | | | | | | |
| (1) Initial | ⊚ | ⊚ | ⊚ | ⊚ | ⊚ | ⊚ | ⊚ | ⊚ | ⊚ | ⊚ | ⊚ | ⊚ | Δ | Δ |
| (2) Resistance to hot | ⊚ | ⊚ | ⊚ | ⊚ | ⊚ | ⊚ | ⊚ | ⊚ | ⊚ | ⊚ | ⊚ | ⊚ | X | X |

(NV: solid concentration)
*¹adhesion to polyethylene

TABLE 1-3
(Component units: weight ratio)

Comparative Example

| | NV | 8 | 9 | 10 |
|---|---|---|---|---|
| Chlorinated PP | 20% | 100 | 100 | 100 |
| Secondary | 100% | | | |
| aminosilane 1 | | | | |
| Primary | 100% | | | |
| aminosilane 2 | | | | |
| Secondary | 100% | | | |
| aminosilane 3 | | | | |
| Ketimine | 100% | | | |
| silane | | | | |
| N- | 100% | 0.5 | | 0.5 |
| ethylaminoethy | | | | |
| lamine | | | | |
| Vinyl trimethox | 100% | | 0.5 | 0.5 |
| ysilane | | | | |
| Phenol resin | 50% | 40 | | 80 |
| Toluene | | 80 | 80 | 80 |

| | | | |
|---|---|---|---|
| <Storage stability> | ∘ | ∘ | ∘ |
| 20° C., 55% | | | |
| RH × 5 days | | | |
| <Adhesion>*¹ | x | x | x |
| (1) Initial | | | |
| (2) Resistance to | x | x | x |
| hot water | | | |

(NV: solid concentration)
*¹adhesion to polyethylene

Each of the components used for the primer composition in Table 1 above is described below.

Chlorinated polypropylene resin: SUPERCHLON™ 851 (available from Nippon Paper Industries Co., Ltd.)

Aminosilane 1: N,N-bis[(3-trimethoxysilyl)propyl]amine (A1170, available from Nippon Unicar Co., Ltd.)

Aminosilane 2: 3-(trimethoxysilyl)propylamine (A1110, available from Nippon Unicar Co., Ltd.)

Aminosilane 3: N-phenyl-γ-aminopropyltrimethoxysilane (Y9669 available from Nippon Unicar Co., Ltd.)

Ketimine silane: N-(1,3-dimethylbutylidene)-3-(triethoxysilyl)-1-propanamine (S340, available from Chisso Corporation)

N-ethylaminoethylamine (available from Koei Chemical Co., Ltd.)

Vinyltrimethoxysilane (A171 available from Nippon Unicar Co., Ltd.)

Phenol resin: magnesium chelate modified alkylphenol resin (Hitanol 2192-50, available from Hitachi Chemicals Co., Ltd.)

From the results shown in Table 1 above, the primer composition of the present invention has a satisfactory adhesion to polyethylene, which is a poorly adhesive polyolefin material. Further, the primer composition excels in adhesion with a modified silicone sealing material and storage stability, thus is useful.

According to the present invention, the primer composition having satisfactory adhesion to the polyolefin material such as polyethylene and polypropylene, and in addition, having satisfactory adhesion with the modified silicone sealing material can be provided.

What is claimed is:

1. A primer composition comprising:
a chlorinated polyolefin resin having a chlorine content of 30% by weight or less; and
one or more kinds of a silane compound selected from the group consisting of a secondary aminosilane compound having a structure represented by the following formulae (1) and (2), and a ketimine silane compound having a structure represented by the following formula (3). 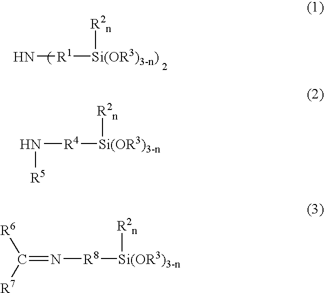
(wherein, R¹ denotes an alkylene group having 1 to 12 carbons; R² and R³ respectively denote independent alkyl groups having 1 to 8 carbons and which may be branched; R⁴ denotes an alkylene group having 1 to 12 carbons; R⁵ denotes an alkyl group having 1 to 8 carbons, an aralkyl group having 7 to 18 carbons, or an aryl group having 6 to 18 carbons, all of which may be branched; R⁶ and R⁷ respectively denote independent monovalent organic groups having 1 to 12 carbons; R⁸ denotes a divalent organic group having 1 to 12 carbons; and n is an integer of 0 to 2. In addition, two or more of R¹, R², and R³ may be identical or different, respectively.)

2. The primer composition according to claim 1, further comprising a phenol resin.

3. A primer composition comprising:
a chlorinated polyolefin resin having a chlorine content of 30% by weight or less;
a primary aminosilane compound having a structure represented by the following formula (4); and
a phenol resin. 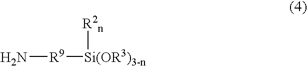
(wherein, R² and R³ respectively denote independent alkyl groups having 1 to 8 carbons and which may be branched; R⁹ denotes an alkylene group having 1 to 12 carbons; and n is an integer of 0 to 2. In addition, two or more of R² and R³ may be identical or different, respectively.)

4. The primer composition according to claim 1, wherein the silane compound is contained in 0.5 to 10 parts by weight with respect to 100 parts by weight of the chlorinated polyolefin resin.

5. The primer composition according to claim 2, wherein the silane compound is contained in 0.5 to 10 parts by weight with respect to 100 parts by weight of the chlorinated polyolefin resin.

6. The primer composition according to claim 3, wherein the silane compound is contained in 0.5 to 10 parts by weight with respect to 100 parts by weight of the chlorinated polyolefin resin.
